(19) United States
(12) Patent Application Publication
(10) Pub. No.: US 2006/0069757 A1
(43) Pub. Date: Mar. 30, 2006

(54) Automated PCN downloads

(76) Inventors: Joseph Stuart Peters, Apex, NC (US); Jay W. Warsaw, Plano, TX (US)

Correspondence Address: SWIDLER BERLIN LLP, 3000 K STREET, NW, BOX IP, WASHINGTON, DC, 20007, US

(21) Appl. No.: 10/953,545

(22) Filed: Sep. 30, 2004

(51) Int. Cl. G06F 15/177

(52) U.S. Cl. 709/220

(57) ABSTRACT

A method, apparatus, and computer program product for comparing a product change notice with a plurality of network equipment is disclosed. Preferably, the method includes automatically obtaining one or more product change notices (PCN's). Preferably, the PCN's are automatically obtained at predetermined time intervals. Once the PCN's have been obtained, it is automatically determined if a plurality of network elements are affected by the one or more PCN's. If any of the network elements are affected by the one or more PCN's, this may be automatically indicated by, for example, flagging affected network elements.

### FIELD OF THE INVENTION

The present invention relates to Product Change Notices (PCN). More specifically, the present invention relates to a method, apparatus, and computer program product that is capable of automatically identifying equipment that is affected by a PCN.

### BACKGROUND OF THE INVENTION

Currently, there are a large number of ways to communicate over long distances. They include television, the Internet, radio, telephones, and the like. More recently, a combination of two or more technologies, such as Internet phones, have begun to emerge. Each of these methods of communication involve different technologies. However, because these different methods of communication are commonplace, it is easy to overlook the technological evolution that is required to provide these different technologies.

Each of the methods of communication typically require an infrastructure. That is, hardware must be constructed and software must be maintained in order to allow signals or packets to be transmitted and received between two or more points. In order to function efficiently, hardware and software need to be monitored and maintained. Maintenance may include repairing, replacing, or updating equipment or software in order to account for newer technologies that are more efficient and/or cost effective.

The telecommunications industry, for example, provides equipment and software that is necessary for networks. Customers that purchase networking equipment typically rely on a document called a product change notice (PCN) that announces problems or manufacturing changes that concern equipment that they use. Any company that has purchased affected equipment is then required to take steps in order to correct the problems. This can include replacing or repairing hardware, or replacing or updating software.

When a new PCN is released, customers usually receive an email notifying them of the release. The customer is then required to download the PCN in the form of a document, usually in .PDF format. Customers are then required to survey their network to determine whether any equipment they own is affected. However, this is a time consuming and error prone process. Customers are required to manually cross-check an inventory of their equipment with the PCN in order to determine if any of their equipment is affected. Because this process is done manually, human error can result in equipment not being updated. Obviously, this can result in problems such as equipment that operates inefficiently, or in some cases, equipment failure.

There is a continuing need for a method and apparatus that is capable of automatically determining when a customer's equipment is affected by a PCN.

### SUMMARY OF THE INVENTION

Product Change Notices (PCN's) are widely used by the telecommunications industry. Their primary purpose is to allow equipment manufacturers to notify their customers, mainly network managers, that their equipment is in need of maintenance. The maintenance that is required may vary. For example, PCN's may notify a network manager that equipment is faulty, and needs to be replaced. Alternately, only a portion of a particular piece of equipment may need to be replaced. Because many pieces of network equipment are run by software, a PCN may also instruct a network manager to update or replace software on a particular piece of equipment.

In one embodiment, the present invention comprises an apparatus for determining if network elements are affected by a product change notice. The apparatus comprises a first server capable of storing one or more product change notices, a plurality of network elements, and a second server operatively connected to the plurality of network elements. The second server is preferably capable of automatically communicating with the first server based on a data network. It may also be desirable for the second server to be capable of automatically obtaining the one or more product change notices from the first server to automatically determine which network elements are affected by the one or more product change notices.

According to one aspect of the present invention, the second server includes a database capable of storing information about each of the plurality of network elements. The second server is preferably capable of automatically determining which network elements are affected by the one or more product change notices in less than about two minutes or less. More preferably, the second server is capable of determining which network elements are affected by the one or more product change notices in less than about one minute.

In one embodiment, the one or more product change notices comprise information about one or more network elements. The second server may be capable of automatically determining which network elements are affected by the one or more product change notices based on comparing the network elements included in the product change notices and the network elements operatively connected to the second server. It may also be desirable for the second server to be capable of automatically indicating which of the plurality of network elements are affected by the one or more product change notices. In some embodiments, the second server may include a user interface that is capable of displaying the automatically indicated network elements that are affected.

It may be desirable for the second sever to be capable of obtaining the one or more product change notices from the first server based on a secure connection. The product change notices may comprise an EDI format. The secure connection may comprise one of HTTPS, Secure FTP, and FTP over HTTPS. In one embodiment, the network elements may include at least one of routers, Add Drop Multiplexers, Next Generation Add Drop Multiplexers, and databases.

According to another aspect, the present invention comprises a method for comparing one or more product change notices with a plurality of network elements. The method preferably includes automatically obtaining one or more product change notices. After obtaining the one or more product change notices, the present invention may be capable of automatically determining if a plurality of network elements correspond to one or more product change notices. The method also includes automatically indicating which of the plurality of network elements correspond to the one or more product change notices.

In one embodiment, the automatically obtaining comprises automatically establishing a connection between a first and second point on a data network and automatically transferring one or more product change notices from the first point to the second point. The automatically determining preferably comprises automatically querying a database to determine the identity of the plurality of network elements. Once the identity of the plurality of network elements has been determined, the identity may be automatically compared with the network elements identified in the one or more product change notices. In one embodiment, the automatically indicating may include automatically flagging network elements affected by the one or more product change notices. A list of the flagged network elements may then be automatically generated. The list may be displayed, for example, automatically based on a user interface.

Preferably, the automatically establishing is based on a secure connection comprising one of HTTPS, FTP over HTTPS, and Secure FTP. In one embodiment, the product change notices may be automatically transferred in EDI format. In other embodiments, the product change notices may be automatically transferred in one of .PDF format, .JPEG format, .JPG format, XML format, and HTML format. Preferably, the automatically determining is completed within about five minutes or less. More preferably, the automatically determining is completed within about two minutes or less. Most preferably, the automatically determining is completed in between about 10 seconds and about five minutes.

According to one aspect, the automatically obtaining is based on a predetermined time period. Preferably, the predetermined time period comprises once about every three months or less. More preferably, the predetermined time period comprises once about every one month or less. Most preferably, the predetermined time period comprises once about every one week or less.

According to another aspect of the present invention, a computer program product for comparing one or more product change notices with a plurality of network elements may be included. The computer program product preferably comprises automatically obtaining one or more product change notices, automatically determining if a plurality of network elements correspond to the one or more product change notices, and automatically indicating which of the plurality of network elements correspond to the one or more product change notices.

In another embodiment, the present invention comprises a method for comparing one or more product change notices with a plurality of network elements. The method includes obtaining one or more product change notices, automatically determining if a plurality of network elements correspond to one or more product change notices, and automatically indicating which of the plurality of network elements correspond to the one or more product change notices.

The obtaining one or more product change notices preferably comprises establishing a connection between a first and second point on a data network and transferring one or more product change notices from the first point to the second point. In some embodiments, the obtaining may optionally be performed automatically. Preferably, the automatically determining is completed within about five minutes or less. More preferably, the automatically determining is completed within about two minutes or less. Most preferably, the automatically determining is completed in between about 10 seconds and about five minutes.

### BRIEF DESCRIPTION OF THE DRAWINGS

Further features and advantages of the invention can be ascertained from the following detailed description that is provided in connection with the drawings described below:

FIG. 1 is a block diagram showing an overview of one embodiment of the present invention; and

FIG. 2 is a more detailed diagram showing the FIG. 1 embodiment.

### DETAILED DESCRIPTION OF THE PREFERRED EMBODIMENTS

Product Change Notices (PCN's) are widely used by the telecommunications industry. Their primary purpose is to allow equipment manufacturers to notify their customers, mainly network managers, that their equipment is in need of maintenance. The maintenance that is required may vary. For example, PCN's may notify a network manager that equipment is faulty, and needs to be replaced. Alternately, only a portion of a particular piece of equipment may need to be replaced. Because many pieces of network equipment are run by software, a PCN may also instruct a network manager to update or replace software on a particular piece of equipment.

Typically, a network manager receives an email from an equipment manufacturer that informs them that a PCN has been released. The network manager is then required to obtain the PCN via an electronic medium, such as downloading it off a website, or possibly through mail, fax, or other means. Once a network manager obtains the PCN, they must compare the equipment listed on the document with the equipment that they are using in their network. A PCN may list many items that require maintenance or replacement. Thus, comparing equipment listed in a PCN with equipment used in a network can potentially be a labor intensive, time consuming process. As a result, equipment that needs maintenance or replacement may be overlooked. This may result in a network that results in delays, inefficient routing of information, failure, and the like.

The present invention relates to a method, apparatus, and computer program product that is capable of automatically determining whether network equipment may be affected by a PCN. According to one aspect, the present invention comprises a method that includes downloading a PCN via, for example, the Internet. Once the PCN has been downloaded, an inventory of network equipment may be compared to the PCN to determine if the inventory of network equipment corresponds to the equipment listed in the PCN. Any matches may be automatically indicated by, for example, flagging the network equipment that requires maintenance.

In one embodiment, once equipment has been flagged, a user such as a network manager may be able to perform the required maintenance on affected equipment. As mentioned above, required maintenance may include, but is not limited to, replacing a piece of equipment, replacing a portion of a piece of equipment, updating or replacing software, and the like. One advantage of automatically identifying equipment that is affected by a PCN is that time may be saved and the cost of identifying the equipment may be reduced. In addition, since human error is minimized, the chance of overlooking equipment that is affected by a PCN is greatly reduced. This can result in improved network operations.

In one embodiment, the present invention may be implemented using, for example, a software program. Preferably, the program may be implemented using, for example, a processor. In one embodiment, the processor preferably includes a user interface that includes a user interface such as a screen, keyboard, and the like. According to one embodiment, the present invention may be included in a network. In such an embodiment, the present invention may be included in one or more pieces of network equipment, or alternately it may be included in a server that resides on the network. In other embodiments, the present invention may be a separate element that is capable of communicating with one or more pieces of network equipment. This may be desirable in embodiments where it is advantageous for the present invention to be capable of monitoring two or more networks that may not be operatively connected.

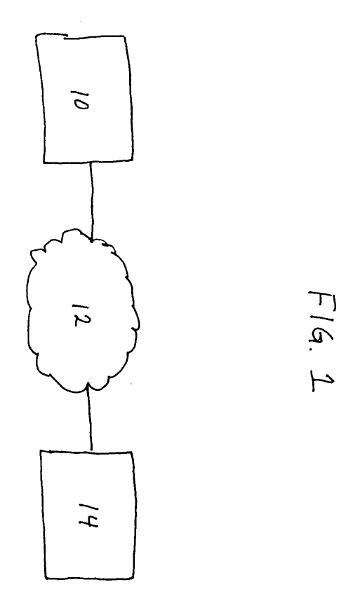

FIG. 1 is a block diagram showing an overview of one embodiment of the present invention. In one embodiment, the present invention comprises two networks 10 and 14 that are operatively connected to a data network 12. The data network may comprise, for example, the Internet. In one embodiment, network 10 comprises the equipment providers network, while network 14 comprises a users network. Preferably, the equipment provider network 10 includes the PCN, which may be downloaded by user network 14 via data network 12.

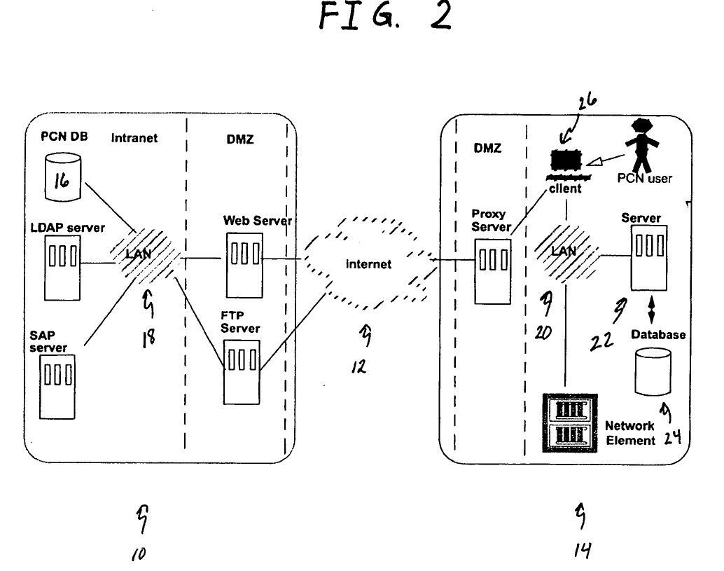

FIG. 2 is a block diagram showing a more detailed view of the FIG. 1 embodiment. As shown in FIG. 2, network 10 includes a plurality of servers that may be operatively connected by a local area network (LAN) 18. Preferably, the servers may be capable of communicating with each other to support a website that is capable of providing access to its content via the Internet 12. In one embodiment, network 10 includes a PCN database 16 that is capable of storing a plurality of PCN's. Typically, each PCN comprises between about 2 KB and about 5 KB of data. Thus, it may be desirable for database 16 to include a storage capacity that is sufficient to store between about 10 and about 500 PCN's. More preferably, it may be desirable for database 16 to include a storage capacity that is sufficient to store between about 30 and about 100 PCN's.

User network 14 may also include a plurality of servers that are operatively connected via a LAN 20. Preferably, user network 14 includes a server 22. According to one aspect of the present invention, the server 22 may comprise a NETSMART 1500 server, developed by Fujitsu Network Communications, Inc. The NETSMART 1500 server is an element management system that is capable of managing network elements, such as routers, Add Drop multiplexers (ADM), Next Generation Add Drop Multiplexers (NGADM's), and the like. In other embodiments, any server known to those skilled in the art may be used.

In one embodiment, the server 22 is capable of communicating with a database 24. The database 24 may be included in the server 22 or it may be a separate element. In one embodiment, the server 22 may be operatively connected to the database 24. Preferably, the database 24 is capable of storing an inventory of each network element that is included in the network 14. In one embodiment, the server 22 is capable of comparing a PCN to the network element inventory stored in the database 24 in order to determine which network elements require maintenance. Once the server 22 determines that one or more network elements are affected by a PCN, it may flag these elements. A network manager may be alerted to the flagged elements via any method, such as email and the like. Alternately, a network manager may interact with the server 22 based on a user interface 26 to determine which network elements have been flagged.

According to one aspect of the present invention, the server 22 is capable of automatically obtaining a PCN. This may be done in any desirable manner. For example, in one embodiment the server 22 is capable of communicating with the PCN database 16 via the Internet 12. In this embodiment, the server 22 is capable of communicating with the PCN database 16 to determine if there are any PCN's available. Preferably, the server 22 is capable of comparing any PCN's that are currently in the database 24 with the available PCN's. If there are PCN's on the PCN database 16 that are not present in the user database 24, the server 22 is capable of downloading the new PCN's. If however, no new PCN's are available, the server 22 may not download anything. It may be desirable for the server 22 to be capable of reconnecting to the PCN database 16 after a predetermined time interval to check for new PCN's.

The user database 24 may have any desired storage capacity, which may depend on, for example, the size of the network. In one embodiment, the user database 24 is preferably capable of storing information regarding about 200 network elements or more. More preferably, the user database 24 may be capable of storing information regarding about 400 network elements or more. Most preferably, the user database 24 may be capable of storing information regarding about 800 network elements or more. Another way to describe the capacity of the database is according to its memory capacity. Preferably, the user database 24 is capable of storing about 10 GB of data or more. More preferably, the user database 24 is capable of storing about 40 GB of data or more. Most preferably, the user database 24 is capable of storing about 100 GB of data or more.

As mentioned above, the server 22 may be capable of automatically obtaining new PCN's from the PCN database 16. Preferably, the server 22 is capable of obtaining the PCN's at predetermined time intervals. The time intervals may be chosen according to the frequency that they are released by an equipment manufacturer. Alternately, if a user network 14 includes equipment from more than one equipment manufacturer, the server 22 may be configured to communicate with each PCN database 16 at predetermined time intervals. In one embodiment, this may be done based on a “live update” feature, which is commonly used by commercially available virus detection programs. In such an embodiment, the “live update” feature may be capable of downloading new PCN's from the PCN database 16 as they become available. In such an embodiment, the new PCN's may be downloaded automatically, or alternately they may prompt a network manager to initiate the downloading process.

In one embodiment, the server 22 is preferably capable of communicating with a PCN database 16 once about every three months or less. More preferably, the server 22 may be capable of communicating with a PCN database 16 once about every two months or less. Most preferably, the server 22 may be capable of communicating with a PCN database 16 once about every one month or less. In another embodiment, the server 22 is preferably capable of communicating with a PCN database 16 once about every month or less. More preferably, the server 22 may be capable of communicating with a PCN database 16 once about every two weeks or less. Most preferably, the server 22 may be capable of communicating with a PCN database 16 once about every week or less.

In another embodiment, the PCN database 16 may be capable of communicating with a user server 22 to notify it when a new PCN is released. This may be done at predetermined time intervals. Alternately, the communication may take place at irregular time intervals in embodiments where PCN's are not released regularly. According to one embodiment, the PCN database 16 may be capable of communicating with the user server 22 by automatically sending an email to the server 22. In one embodiment, the email may be checked by a network manager, who may then manually connect to the PCN database 16 in order to download the new PCN.

According to one aspect of the present invention, the PCN database 16 is capable of communicating with more than one server 22 simultaneously. Preferably, the PCN database 16 is capable of communicating with about 200 or more servers 22 simultaneously. More preferably, the PCN database 16 is capable of communicating with about 500 or more servers simultaneously. Most preferably, the PCN database 16 is capable of communicating with about 1000 or more servers simultaneously.

The user server 22 may connect to the PCN database 16 in any desirable manner. Those skilled in the art will recognize that there are many acceptable methods of communication between two servers operatively connected to the Internet, any of which may be used in accordance with the present invention. In one embodiment, for example, PCN's may be transferred in the Electronic Data Interchange (EDI) format. In other embodiments, PCN's may be transferred as Extensible Markup Language (XML) or Hyper Text Markup Language (HTML) documents. In other embodiments, PCN's may be transferred in the .JPEG format, .JPG format, .PDF format, .TIF format, and the like.

It many applications, it may be desirable to transfer a PCN between networks 10 and 14 via a secure connection. In such embodiments, it may be desirable to use, for example, Secure FTP, FTP over HTTPS, and the like. However, in other embodiments it may be desirable to transfer PCN's based on HTTP, FTP, SMTP, and the like. In one embodiment, it may be desirable to include an authenticity check that is capable of preventing unauthorized users from accessing the PCN database 16. The authenticity check may require, for example, a user to be pre-registered with a user ID and a password. The user server 22 may then be required to enter the user ID and password before access to the database 16 is granted. In such an embodiment, the network manager may be required to enter the user ID or password. Alternately, however, the user ID and password may be stored in a memory that is operatively connected to the server 22 such that the server 22 is capable of accessing the PCN database 16 with substantially little manual intervention.

According to one embodiment, substantially after one or more PCN's are downloaded based on the Internet 12, a processor included in the user server 22 determines which network elements are listed in the PCN. The server 22 then communicates with the database 24 to determine which network elements are included in the user network 14. In one embodiment, the server 22 and/or database 24, either alone or in combination, are capable of determining which network elements are included in the network. Preferably, the server 22 is capable of querying each network element to determine its information, such as manufacturer's number, position on the network, other elements to which it is operatively connected, and the like. It is desirable for each piece of network equipment to be capable of responding to such a query to provide the server 22 with the desired information. One advantage of having the server 22 be capable of querying each network element is that substantially minimal user intervention may be necessary, resulting in time and cost savings. Another advantage of having a server 22 that is capable of querying each network element is that equipment that is added, removed, moved, or replaced can be accounted for easily and efficiently. After querying the network elements, the elements included in the network 14 and the elements included in the PCN may then be compared based on, for example, the processor that is included in the server 22. If any network elements are affected by the PCN, they may be flagged. It may be desirable for the processor to automatically generate a list of the affected network elements so that the network manager may easily identify them.

As mentioned above, one advantage of the present invention is that the network elements affected by a PCN are automatically flagged. This results in significant time savings which were not previously possible. In some applications, the present invention is capable of significantly reducing the time required to determine which network elements are affected, and to generate a report, compared to manual methods that were used previously. In one embodiment, the present invention is preferably capable of automatically determining which network elements are affected by a PCN in about 5 minutes or less. More preferably, the present invention may be capable of automatically determining which network elements are affected by a PCN in about 2 minutes or less. Most preferably, the present invention may be capable of automatically determining which network elements are affected by a PCN in about 1 minute or less. In another embodiment, the present invention is preferably capable of determining which network elements are affected by a PCN in between about 10 seconds and about 5 minutes. More preferably, the present invention may be capable of determining which network elements are affected by a PCN in between about 30 seconds and about 2 minutes. Most preferably, the present invention may be capable of determining which network elements are affected by a PCN in between about 45 seconds and about 75 seconds.

According to another aspect of the present invention, the present invention may not be limited to PCN's. In one embodiment, it may be desirable for the user server 22, as described above, to be capable of communicating with the any of the plurality of servers included in network 10. This may be desirable in a variety of applications to allow server 22 to download other programs, files, and the like. For example, in one embodiment it may be desirable for the server 22 to download patches and/or licenses for software that is executed by the server 22. In other embodiments, it may be desirable to download product specifications, new product information, and the like.

As mentioned above, in one embodiment the present invention may be implemented based on a computer program. The program may be implemented based on, for example, a processor that is included in the server 22. In another embodiment, however, the present invention may comprise a computer program product that is capable of performing one or more of the functions described above. As used herein, a computer program product may include, but is not limited to, computer code, computer disks, code stored in a memory, devices capable of implementing computer code, a computer readable medium, computer program instructions recorded on a computer readable medium executable by a processor, and the like.

Although the present invention has been described with reference to particular embodiments, it will be understood to those skilled in the art that the invention is capable of a variety of alternative embodiments within the spirit of the appended claims.

1. An apparatus for determining if network elements are affected by a product change notice, comprising:
a first server capable of storing one or more product change notices;
a plurality of network elements;
a second server operatively connected to the plurality of network elements, wherein:
the second server is capable of automatically communicating with the first server based on a data network;
the second server is capable of automatically obtaining the one or more product change notices from the first server; and
the second server is capable of automatically determining which network elements are affected by the one or more product change notices.

2. The apparatus according to claim 1, wherein the second server includes a database capable of storing information about each of the plurality of network elements.

3. The apparatus according to claim 1, wherein the second server is capable of automatically determining which network elements are affected by the one or more product change notices in less than about two minutes or less.

4. The apparatus according to claim 1, wherein the second server is capable of determining which network elements are affected by the one or more product change notices in less than about one minute.

5. The apparatus according to claim 1, wherein the one or more product change notices comprise information about one or more network elements.

6. The apparatus according to claim 5, wherein the second server is capable of automatically determining which network elements are affected by the one or more product change notices based on comparing the network elements included in the product change notices and the network elements operatively connected to the second server.

7. The apparatus according to claim 1, wherein the second server is capable of automatically indicating which of the plurality of network elements are affected by the one or more product change notices.

8. The apparatus according to claim 1, wherein the second server includes a user interface.

9. The apparatus according to claim 1, wherein the product change notices comprise an EDI format.

10. The apparatus according to claim 1, wherein the second server obtains the one or more product change notices from the first server based on a secure connection.

11. The apparatus according to claim 10, wherein the secure connection comprises one of HTTPS, Secure FTP, and FTP over HTTPS.

12. The apparatus according to claim 1, wherein the network elements include at least one of routers, Add Drop Multiplexers, Next Generation Add Drop Multiplexers, and databases.

13. A method for comparing one or more product change notices with a plurality of network elements, comprising:
automatically obtaining one or more product change notices;
automatically determining if a plurality of network elements correspond to one or more product change notices; and
automatically indicating which of the plurality of network elements correspond to the one or more product change notices.

14. The method according to claim 13, wherein the automatically obtaining comprises:
automatically establishing a connection between a first and second point on a data network; and
automatically transferring one or more product change notices from the first point to the second point.

15. The method according to claim 13, wherein the automatically determining comprises:
automatically querying a database to determine the identity of the plurality of network elements; and
automatically comparing the identity of the plurality of network elements with network elements identified in the one or more product change notices.

16. The method according to claim 13, wherein the automatically indicating comprises:
automatically flagging network elements affected by the one or more product change notices;
automatically generating a list of the flagged network elements; and
automatically displaying the list based on a user interface.

17. The method according to claim 14, wherein the automatically establishing is based on a secure connection comprising one of HTTPS, FTP over HTTPS, and Secure FTP.

18. The method according to claim 14, wherein the product change notices are automatically transferred in EDI format.

19. The method according to claim 14, wherein the product change notices are automatically transferred in one of .PDF format, .JPEG format, .JPG format, XML format, and HTML format.

20. The method according to claim 13, wherein the automatically determining is completed within about five minutes or less.

21. The method according to claim 13, wherein the automatically determining is completed within about two minutes or less.

22. The method according to claim 13, wherein the automatically determining is completed in between about 10 seconds and about five minutes.

23. The method according to claim 13, wherein the automatically obtaining is based on a predetermined time period.

24. The method according to claim 23, wherein the predetermined time period comprises once about every one week or less.

25. The method according to claim 23, wherein the predetermined time period comprises once about every one month or less.

26. The method according to claim 23, wherein the predetermined time period comprises once about every three months or less.

27. A computer program product for comparing one or more product change notices with a plurality of network elements, comprising:
automatically obtaining one or more product change notices;
automatically determining if a plurality of network elements correspond to the one or more product change notices; and
automatically indicating which of the plurality of network elements correspond to the one or more product change notices.

28. The method according to claim 27, wherein the automatically obtaining comprises:
automatically establishing a connection between a first and second point on a data network; and
automatically transferring one or more product change notices from the first point to the second point.

29. The method according to claim 27, wherein the automatically determining comprises:
automatically querying a database to determine the identity of the plurality of network elements; and
automatically comparing the identity of the plurality of network elements with network elements identified in the one or more product change notices.

30. The method according to claim 27, wherein the automatically indicating comprises:
automatically flagging network elements affected by the one or more product change notices;
automatically generating a list of the flagged network elements; and
automatically displaying the list based on a user interface.

31. The method according to claim 28, wherein the automatically establishing is based on a secure connection comprising one of HTTPS, FTP over HTTPS, and Secure FTP.

32. The method according to claim 28, wherein the product change notices are automatically transferred in EDI format.

33. The method according to claim 28, wherein the product change notices are automatically transferred in one of .PDF format, .JPEG format, .JPG format, XML format, and HTML format.

34. The method according to claim 27, wherein the automatically determining is completed within about five minutes or less.

35. The method according to claim 27, wherein the automatically determining is completed within about two minutes or less.

36. The method according to claim 27, wherein the automatically determining is completed in between about 10 seconds and about five minutes.

37. The method according to claim 27, wherein the automatically obtaining is based on a predetermined time period.

38. The method according to claim 37, wherein the predetermined time period comprises once about every one week or less.

39. The method according to claim 37, wherein the predetermined time period comprises once about every one month or less.

40. The method according to claim 37, wherein the predetermined time period comprises once about every three months or less.

41. A method for comparing one or more product change notices with a plurality of network elements, comprising:
obtaining one or more product change notices;
automatically determining if a plurality of network elements correspond to one or more product change notices; and
automatically indicating which of the plurality of network elements correspond to the one or more product change notices.

42. The method according to claim 41, wherein the obtaining comprises:
establishing a connection between a first and second point on a data network; and
transferring one or more product change notices from the first point to the second point.

43. The method according to claim 41, wherein the obtaining is performed automatically.

44. The method according to claim 41, wherein the automatically determining comprises:
automatically querying a database to determine the identity of the plurality of network elements; and
automatically comparing the identity of the plurality of network elements with network elements identified in the one or more product change notices.

45. The method according to claim 41, wherein the automatically indicating comprises:
automatically flagging network elements affected by the one or more product change notices;
automatically generating a list of the flagged network elements; and
automatically displaying the list based on a user interface.

46. The method according to claim 42, wherein the establishing is based on a secure connection comprising one of HTTPS, FTP over HTTPS, and Secure FTP.

47. The method according to claim 42, wherein the product change notices are transferred in EDI format.

48. The method according to claim 42, wherein the product change notices are transferred in one of .PDF format, .JPEG format, .JPG format, XML format, and HTML format.

49. The method according to claim 41, wherein the automatically determining is completed within about five minutes or less.

50. The method according to claim 41, wherein the automatically determining is completed within about two minutes or less.

51. The method according to claim 41, wherein the automatically determining is completed in between about 10 seconds and about five minutes.

52. The method according to claim 41, wherein the obtaining is based on a predetermined time period.

53. The method according to claim 41, wherein the predetermined time period comprises once about every one week or less.

54. The method according to claim 41, wherein the predetermined time period comprises once about every one month or less.

55. The method according to claim 41, wherein the predetermined time period comprises once about every three months or less.
